(19) United States
(12) Patent Application Publication
(10) Pub. No.: US 2024/0161176 A1
(43) Pub. Date: May 16, 2024

(54) CLUSTER-BASED DYNAMIC CONTENT WITH MULTI-DIMENSIONAL VECTORS

(71) Applicant: Loop Now Technologies, Inc., San Mateo, CA (US)

(72) Inventors: Edwin Chiu, Cupertino, CA (US); Vishal Arora, Walnut Creek, CA (US); Shi Feng, Union City, CA (US); Jerry Ting Kwan Luk, Menlo Park, CA (US); Ziming Zhuang, Palo Alto, CA (US)

(73) Assignee: Loop Now Technologies, Inc., San Mateo, CA (US)

(21) Appl. No.: 18/388,556

(22) Filed: Nov. 10, 2023

Related U.S. Application Data
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/546,077, filed on Oct. 27, 2023.
(60) Provisional application No. 63/546,768, filed on Nov. 1, 2023.

(51) Int. Cl. G06Q 30/0601; G06Q 30/0204

(52) U.S. Cl. CPC G06Q 30/0641; G06Q 30/0204; G06Q 30/0633

(57) ABSTRACT

Disclosed techniques enable cluster-based dynamic content with multi-dimensional vectors for video content analysis. User-specific data vectors on a plurality of users are accessed, which include shopping history and video consumption behavior. A plurality of clusters, based on the user-specific data vectors, is developed. A user, from the plurality of users, is associated with one or more clusters from the plurality of clusters. The user is identified as viewing media content. A container unit is inserted into the media content that is being viewed and is populated with at least one short-form video from a library of short-form videos. The populating is based on the identifying. An ecommerce purchase of a product for sale to the user is enabled. The product for sale is relevant to the one or more clusters and the at least one short-form video. The ecommerce purchase is accomplished within a short-form video window.

### RELATED APPLICATIONS

This application claims the benefit of U.S. provisional patent applications “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, and “AI-Driven Suggestions For Interactions With A User” Ser. No. 63/546,768, filed Nov. 1, 2023.

Each of the foregoing applications is hereby incorporated by reference in its entirety.

### FIELD OF ART

This application relates generally to digital media and more particularly to cluster-based dynamic content with multi-dimensional vectors.

### BACKGROUND

Short-form videos can be used to provide an authentic engagement experience with a product or service. Popular content creators can serve as influencers. When these influencers discuss, demonstrate, or promote a product, many advertising impressions can be created. Furthermore, some demographics do not engage substantially with more traditional advertising mediums such as magazines and network television. For these demographics, short-form videos can be the best way to reach them. These short-form videos can last anywhere from a few seconds to several minutes. Many mobile electronic devices, such as smartphones, tablet computers, and wearable computing devices, include one or more cameras onboard. Some devices may include multiple cameras, including wide-angle, ultrawide, and telephoto lenses, along with stereo microphones. Advanced image processing such as stabilization, high dynamic range (HDR), selective focus, and various other video effects empower individuals to create content on their mobile devices that would have required a professional studio just a short time ago. Thus, nearly anyone with a mobile device and an internet connection has the resources to become a content creator if they choose to do so. This has caused the amount of short-form video content to increase considerably in recent years. The short-form videos cover a variety of topics. Important subcategories of short-form videos include livestreams and livestream replays.

Livestreaming refers to video that is distributed over a network in near real time, without first being recorded in its entirety. Livestreaming can include broadcast livestreams, which are one-to-many connections that are sent to multiple devices simultaneously via broadcast or multicast network connections. Livestreaming may utilize various real-time communication protocols such as Real-Time Streaming Protocol (RTSP), HTTP Live Streaming (HLS), Secure Reliable Transport (SRT), and/or other suitable protocols. In addition to the ease of creating content, modern technology also enables easy consumption of content. Individuals are now able to consume video from almost anywhere on their mobile electronic devices, such as smartphones or tablet computers. Especially on mobile devices, social media platforms have become an extremely common use of internet-based video. Internet-based video can be accessed through the use of a browser or specialized app that can be downloaded from a variety of services. While these services vary in their video capabilities and features, they are generally able to display short video clips, repeating video “loops”, livestreaming, music videos, etc. These videos can last anywhere from a few seconds to an hour or more. Countless hours are spent online watching an endless supply of videos from friends, family, social media “influencers”, gamers, favorite sports teams, or other sources.

Making short-form videos part of a product engagement and/or promotional strategy allows engagement with audiences that typically ignore traditional advertising outlets. Short-form videos can be easily shared among friends via email, texting, and/or posting on social media. This further increases the potential advertising impressions of products that are discussed and/or demonstrated in the short-form videos. Thus, short-form videos are an important part of a product launch strategy, public relations campaign, or other marketing efforts that strive to reach a wide audience.

### SUMMARY

Short-form videos are very useful in product promotion, as they can be used to create engaging experiences that enhance entertainment value, while also educating potential consumers about the features of a product or service. An important aspect of the use of short-form videos is making sure that the short-form videos are presented to an appropriate audience. Disclosed embodiments provide techniques for short-form video dissemination by utilizing clustering with multi-dimensional vectors. This approach helps increase the likelihood that a short-form video is presented to users that will want to engage with the content. In embodiments, a container unit is rendered on the display of a mobile electronic device such as a smartphone or tablet computer. Videos are presented within the container unit in a variety of arrangements, allowing the viewer to select one or more short-form videos for viewing.

Disclosed techniques enable cluster-based dynamic content with multi-dimensional vectors for video content analysis. User-specific data vectors on a plurality of users are accessed, which include shopping history and video consumption behavior. A plurality of clusters, based on the user-specific data vectors, is developed. A user, from the plurality of users, is associated with one or more clusters from the plurality of clusters. The user is identified as viewing media content. A container unit is inserted into the media content that is being viewed and is populated with at least one short-form video from a library of short-form videos. The populating is based on the identifying. An ecommerce purchase of a product for sale to the user is enabled. The product for sale is relevant to the one or more clusters and the at least one short-form video. The ecommerce purchase is accomplished within a short-form video window.

A computer-implemented method for video content analysis is disclosed comprising: accessing user-specific data vectors on a plurality of users, wherein the user-specific data vectors include shopping history and video consumption behavior; developing, using one or more processors, a plurality of clusters based on the user-specific data vectors; associating a user from the plurality of users with one or more clusters from the plurality of clusters; identifying that the user, from the plurality of users, is viewing media content, wherein the user is associated with the one or more clusters; inserting a container unit into the media content that is being viewed by the user; populating the container unit with at least one short-form video from a library of short-form videos, wherein the populating is based on the identifying; and enabling an ecommerce purchase of a product for sale to the user, wherein the product for sale is relevant to the one or more clusters and the at least one short-form video, and wherein the ecommerce purchase is accomplished within a short-form video window. Some embodiments comprise creating a user-specific data vector, based on gathering of shopping history, for inclusion in the user-specific data vectors on the plurality of users. In embodiments, the user-specific data vector is updated dynamically. Some embodiments comprise inferring, using one or more processors, additional information about the plurality of users, wherein the inferring is based on the gathering, and wherein the additional information is added to the user-specific data vector. In embodiments, the inferring includes a prediction of biographic, geographic, or demographic information. Some embodiments comprise collecting video consumption behavior information on the plurality of users.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cluster-based content with multi-dimensional vectors.

FIG. 2 is a flow diagram for creating a user-specific data vector.

FIG. 3 is an infographic for cluster-based dynamic content with multi-dimensional vectors.

FIG. 4 is an infographic for creating a user-specific multi-dimensional vector.

FIG. 5 is an infographic for creating clusters.

FIG. 6 is a diagram for replacing videos.

FIG. 7 is a diagram showing clustering with machine learning.

FIG. 8 is an infographic for associating user-specific vectors with clusters.

FIG. 9 shows populating of a container unit.

FIG. 10 shows an ecommerce purchase with a container unit.

FIG. 11 shows an ecommerce purchase with coupon overlay.

FIG. 12 is a system diagram for cluster-based dynamic content with multi-dimensional vectors.

### DETAILED DESCRIPTION

Techniques for video content are disclosed. Embodiments include accessing user-specific data vectors on multiple users. The user-specific data vectors can include shopping history and video consumption behavior. The shopping history can include online shopping history. The shopping history can include offline shopping history, where the offline shopping history includes shopping history at physical retail establishments (brick-and-mortar stores). Embodiments include developing multiple clusters based on the user-specific data vectors. Embodiments can use hierarchical clustering or non-hierarchical clustering. With non-hierarchical clustering, a dataset containing N objects is divided into M clusters. In some embodiments, the non-hierarchical clustering technique includes a K-means algorithm and/or bisecting K-means algorithm. Embodiments include associating a user with one or more clusters. The clusters can represent a preference, such as a shopping preference and/or video viewing preference. When the user is viewing media content, a container unit is inserted into the media content. The container unit can display multiple short-form videos with static thumbnails, motion thumbnails, and/or other suitable techniques. The container is populated with one or more short-form videos based on the identifying of preferences made with the clustering analysis of multiple user-specific data vectors. An ecommerce purchase of a product for sale is then enabled, where the product for sale is relevant to the cluster and one or more corresponding short form videos, and where the ecommerce purchase is accomplished within the short-form video window. Thus, disclosed embodiments enable dissemination of short-form video content based on clustering of multi-dimensional vectors to provide a comprehensive assessment of a user's likely preference for short-form videos and related products that would be otherwise unavailable.

Online activities of an individual, such as browsing webpages, making ecommerce purchases, and viewing short-form videos can provide insight into the interests and preferences of that individual. However, as most everyone also has a component of his/her life that is not performed online, online activities alone may not enable a comprehensive assessment of individual preferences. Disclosed embodiments also consider non-online activities, referred to as “offline” activities, along with the online activities, enabling a more complete assessment of individual preferences. In embodiments, a multi-dimensional user-specific vector is used as a representation of the combined online and offline activities and/or user actions.

The multi-dimensional vectors used with disclosed embodiments can include data on user behaviors and actions. The behaviors and actions can include video viewing history. The behaviors and actions can include activity at one or more brick-and-mortar establishments. Combining online and “offline” (brick and mortar) behaviors and activities can serve to create a more complete profile of a user, which can be used as guidance for dissemination of short-form video content to enhance product promotion, as well as other actions. The multi-dimensional vectors can include tuples of information. The information can include online actions, such as viewing history, posting history, browsing history, and the like. The information can include “offline” actions. Offline actions refer to actions performed outside of the Internet. The offline actions can include visiting a retail (brick and mortar) establishment, purchasing goods and/or services at a retail establishment, and the like.

The combining of online actions and offline actions into a multi-dimensional vector provides a comprehensive numerical representation of consumer behavior. The clustering techniques can include Centroid-based Clustering, Hierarchical Clustering, Distribution-based Clustering, Density-based Clustering, and/or other suitable clustering techniques. The multi-dimensional vectors from different users can be analyzed using clustering techniques. The clustering techniques can be used to identify users that are similar to each other. Once clusters are established, and a new multi-dimensional vector becomes available, a cluster analysis can be applied to determine which cluster most closely matches the attributes of the multi-dimensional vector. Short-form videos can be associated with different clusters, such that upon analyzing the multi-dimensional vector associated with a user, short-form videos associated with clusters that match or correlate to the multi-dimensional vector can be disseminated to that user.

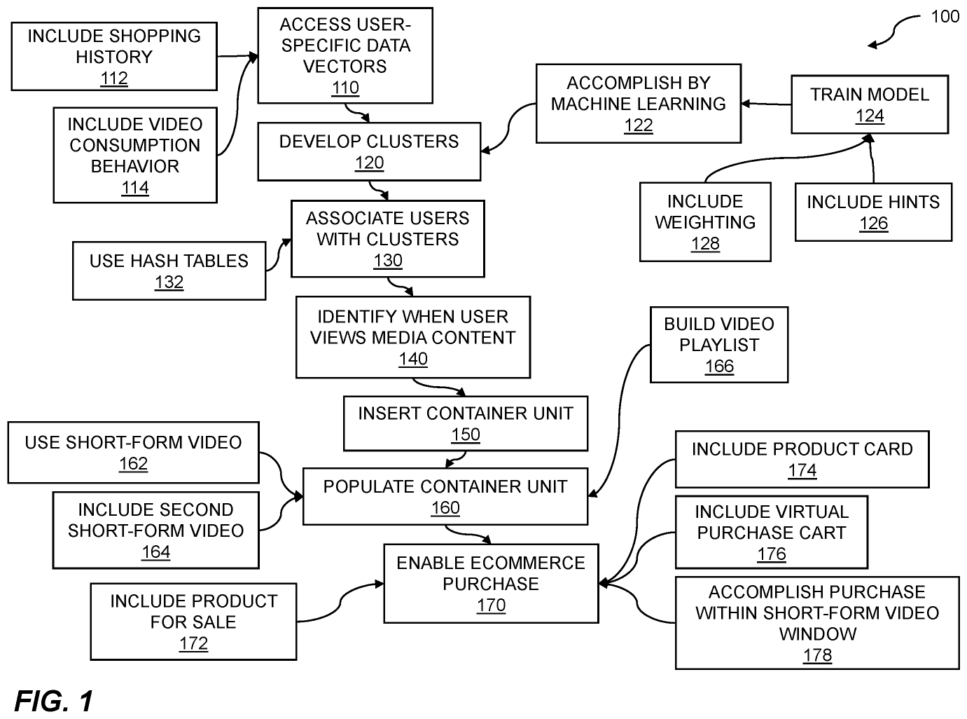

FIG. 1 is a flow diagram 100 for cluster-based content with multi-dimensional vectors. The flow includes accessing user-specific data vectors 110. The user-specific data vectors can include metadata. The metadata can include a username and account number, as well as demographic information such as age, income range, etc. The user-specific data vectors can include shopping history 112. The shopping history can include online shopping history. The shopping history can include visits and/or purchases at retail (brick and mortar) establishments, referred to in this disclosure as “offline” shopping. The user-specific data vectors can include a dwell factor. The dwell factor is a metric of how long a user stays at a retail store or stays on an ecommerce webpage. The dwell factor can be an indicator of interest. As an example, a user that spends an hour in a cosmetic store may have a stronger interest in cosmetics than a second user that spends five minutes in a cosmetic store. The user-specific data vectors can include video consumption behavior 114. The video consumption behavior can include the channels the user typically views; the programs they typically view; the subject matter they typically view; the duration they typically view; the amount of pausing, fast forwarding, and rewinding they typically perform; and so on.

The flow includes developing clusters 120. The clusters can be developed via Centroid-based Clustering, Hierarchical Clustering, Distribution-based Clustering, Density-based Clustering, and/or other suitable clustering techniques. In some embodiments, the clustering is accomplished by machine learning 122. In some embodiments, K-means clustering is used to perform the clustering. In some embodiments, supervised machine learning is used. Embodiments can include training a machine learning model 124. The training can include weighting 128. The weighting can include weighting shopping history and/or video consumption behaviors. The weighting can include adjusting coefficients that affect scores or metrics that are computed based on shopping history and/or video consumption history. As an example, if a user views many videos on bicycles, a weighting may be increased for shopping history relevant to bicycles. The weighting can accelerate clustering, by emphasizing important behaviors and activities, while deemphasizing less important behaviors and activities.

The training can include hints 126. The hints can include additional information provided to a machine learning system for training purposes. The hints can include monotonicity hints, symmetry hints, and others. The hints can be used to guide machine learning systems towards more correct outputs by inferring knowledge of trends. As an example, a hint can be used to indicate, to a machine learning system, that an impending snowstorm affects consumer behavior in particular ways, such as purchasing snack food, an increase in online video streaming, and so on. The hints can accelerate the training of a machine learning system such that it can make more efficient use of user-specific vector data.

The flow includes associating users with clusters 130. The clustering can be performed utilizing a variety of techniques, including, but not limited to, Connectivity-based Clustering (Hierarchical clustering), Centroids-based Clustering (Partitioning methods), Distribution-based Clustering, Density-based Clustering (Model-based methods), Fuzzy Clustering, and/or Constraint-based (Supervised Clustering). The clustering can be used to identify groups of similar users based on their corresponding user-specific multi-dimensional vectors. The vectors may be represented as arrays, or other suitable data structures within a computer environment. The flow can include using hash tables 132. The hash tables can be used for managing databases of users and corresponding metadata. The use of hash tables can improve efficiency in retrieval of data. Embodiments may utilize an associative array, dictionary, or other data structure that utilizes key-value pairs, along with the hash tables for accessing user-specific vector data.

The flow includes identifying when a user views media content 140. In embodiments, this is accomplished via a callback mechanism from a short-form video library or server. When a request, such as through an HTTP call, for a video is received at the short-form video library/server, a callback executes which can send a message to an identifying engine. The message can include metadata, such as a video title, user ID, time of day, video subject, demographic information, and/or other metadata. In some embodiments, the metadata may be anonymized, such that the user ID is removed or scrambled. This enables protection of individual privacy, while still enabling clustering analysis of user-specific data vectors based on demographic information, video viewing behavior, shopping preferences, and so on.

The flow includes inserting a container unit 150. The container unit is inserted in a region of an electronic display executing an application and/or browser. The container unit comprises a graphics region allocated for representation of short-form videos. The representation can include static and/or motion thumbnails, icons, hyperlinks, and/or other suitable representations. The flow continues with populating the container unit 160. The populating can include using a short-form video 162. The populating can include using a second short-form video 164. The populating can include building a video playlist 166. The video playlist can include multiple short-form videos. The short-form videos can be automatically selected based on user-specific vector data. In this way, a user is served videos that he/she is likely to engage with. In embodiments, the building a video playlist is based on hints, wherein the hints include biographic information, demographic information, geographic information, or shopping history.

The flow includes enabling an ecommerce purchase 170. The enabling of the ecommerce purchase can include a product for sale 172. The product for sale can be based on user-specific vector data. The product for sale can be based on engagement with a short-form video that is in the container unit. The flow can include a product card 174. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The flow can include accomplishing a purchase within the short-form video window 178. When the product card is invoked, an additional on-screen display is rendered over a portion of the video while the video continues to play. This enables a user to purchase a product/service while preserving a continuous video playback session. In other words, the user is not redirected to another site or portal that causes the video playback to stop. Thus, users are able to initiate and complete a purchase completely inside of the video playback user interface, without being directed away from the currently playing video. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The flow can include a virtual purchase cart 176. In embodiments, a virtual purchase cart is used to support completion of an ecommerce transaction to purchase the product, including specifying various payment methods, and application of coupons and/or promotional codes. In some embodiments, the payment methods can include fiat currencies such as United States dollars (USD), as well as virtual currencies, including cryptocurrencies such as Bitcoin.

In embodiments, the developing a plurality of clusters is accomplished by machine learning. Embodiments can include training a machine learning model. In embodiments, the training includes weighting shopping history or video consumption behaviors within the user-specific vector data. The training can include hints, based on prior knowledge of shopping history. The hints are based on the video consumption. Embodiments can include deploying the machine learning model that was trained to develop the plurality of clusters. In embodiments, the populating includes a second short-form video. The populating the container unit further comprises, for each cluster within the plurality of clusters, building a video playlist, wherein the video playlist includes one or more related videos to the cluster from the library of short-form videos. The building a video playlist includes the ability to replace the one or more related videos with one or more alternate videos from the library of short form videos.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

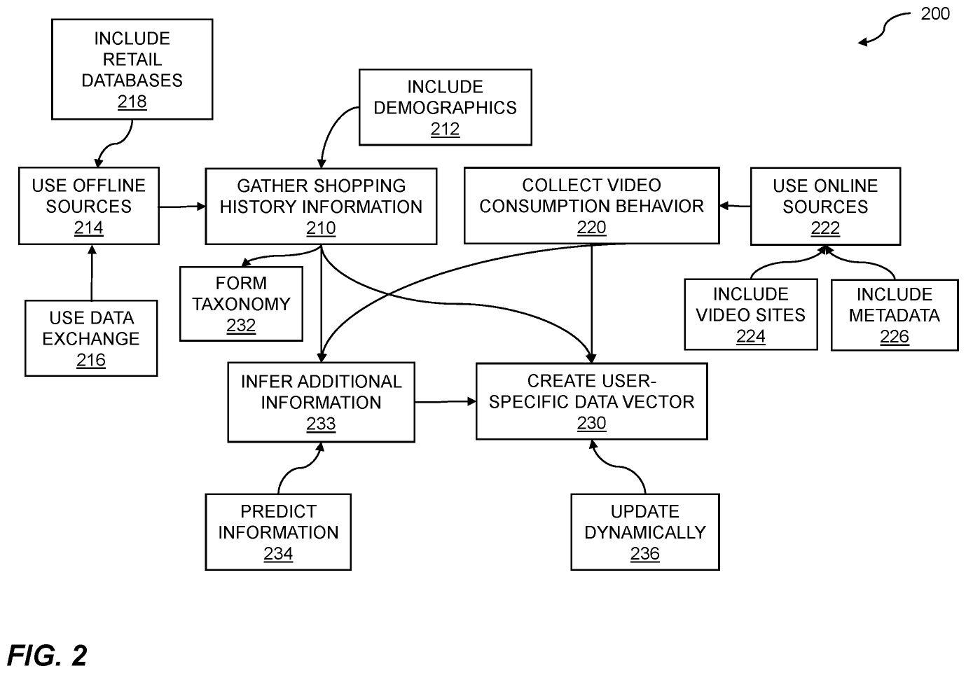

FIG. 2 is a flow diagram 200 for creating a user-specific data vector. In embodiments, the associating a user from the plurality of users is accomplished using hash tables. The flow 200 can include gathering shopping history information 210. In embodiments, the shopping history information can come from a frequent shopper card, account, app, or other source of shopping history information. The shopping history information can include information on shopping frequency (how often the user visits a retail store or online website), shopping dwell time (how long the user remained at a retail store or online website), shopping budget (average amount spent per shopping visit), shopping schedule (e.g., which days, and/or time of day, the user typically shops), items purchased, coupons used, and/or other shopping history information. The flow can include demographics 212. The demographics can include an age range, gender, income level, race, ethnicity, and/or other demographic information. In embodiments, the information is provided by a user as part of an opt-in from acceptance of an end-user license agreement. The gathering of shopping history can include use of offline sources 214. The offline sources can be associated with physical retail (brick and mortar) establishments. The offline sources can include retail databases 218. The retail databases can include records from shoppers and/or visitors to retail establishments. The records can include total purchase amount, list of items purchased, dwell time (time spent in the retail establishment), and so on. The retail establishments can be small independent retailers, and/or larger shopping chains. The flow can include using a data exchange 216 to facilitate sharing of offline source data. Note in this context, “offline” does not refer to a network connection state, but rather to the type of consumer activity as not occurring “online”. That is, offline sources refer to user activities in physical retail establishments as compared to online activities using an ecommerce website. The data exchange can be based on a database server, such as a SQL server, that enables retail establishments to upload customer data on a periodic basis. The flow can include forming a taxonomy 232. The taxonomy can include purchase details. The purchase details can include payment methods, payment amounts, shipping destination, shipping methods, if the purchase is intended as a gift, and so on.

The flow includes collecting video consumption behavior 220. The video consumption behavior collection can use online sources 222. The online sources can include video sites 224. The video sites can include social media websites, video sharing websites, content delivery network websites, and so on. The collecting of video consumption behavior can include metadata 226. The metadata can include duration of viewing; hashtags; type of device used for viewing; repost velocity; participant attributes, such as age, gender, income level, and the like; participant history, such as previously viewed videos and/or channels; ranking; purchase history; view history; and/or other participant actions.

The flow includes creating a user-specific data vector 230. In embodiments, the data vector can be represented as a data structure within a computer system. The data structure can include an array, a relational database, a collection of linked lists, and/or some other suitable data structure or structures. The data within the user-specific data vector can include metrics, scores, rankings, and/or other numerical indications of attributes. As an example, a user-specific data vector can include an affinity score for multiple categories, where the categories pertain to interests and/or activities. The categories can include sports, movies, music, television, cooking, fashion, sewing, pottery, painting, automobiles, and so on. In some embodiments, the categories can be expanded to provide more granularity via the use of linked subcategories. As an example, linked subcategories for sports can include specific sports, such as baseball, basketball, bowling, and so on. In embodiments, categories are represented as an X dimension, the corresponding values are represented as a Y dimension, and each user-specific data vector defines a curve in X-Y space. Some embodiments may utilize more than two dimensions. By clustering, similar curves can be grouped together to enable classification of user-specific data vectors. The flow can include dynamic updating 236. The dynamic updating can include editing values within a user-specific data vector, and tracking the behavior and/or habits of a user over time. The flow can include inferring additional information 233. The inferring can include estimating demographic information such as age range and/or gender based on shopping history information and/or video consumption behavior. The inferred information can be used where the actual information is missing. In embodiments, as actual information is acquired, it can be used to update the inferred information. In embodiments, the degree to which the inferred information and actual information are in agreement can be used as training feedback for machine learning systems.

As an example, a user-specific data vector may indicate an affinity for watching videos on cosmetics and visiting cosmetic retail stores and cosmetic ecommerce sites. The system may infer, based on clustering, that the user-specific data vector belongs to a user that is female, with an age range of 16-24. Later, if the user registers a profile with a retail establishment, the actual information can be obtained via a data exchange, and then the inferred information can be updated with the actual information. If in fact the user happens to be a female with an age range of 16-24, the machine learning decision is scored positively. If the actual data for the user-specific data vector does not correspond to the inferred data, then the machine learning decision is scored negatively. The scoring can be used to continuously train the machine learning systems to improve the accuracy of the inferred information over time. The flow can include predicting information 234. The predicting can include demographic, biographic, and/or geographic information. As an example, if the video consumption behavior includes watching many videos of the Boston Red Sox baseball team, then the predicting may include predicting that the user is located in the Boston vicinity.

Embodiments can include creating the user-specific data vector, based on the gathering and the collecting. Embodiments can include creating a user-specific data vector, based on the gathering of shopping history. In embodiments, the user-specific vector data is updated dynamically. Embodiments can include inferring, using one or more processors, additional information about the plurality of users, wherein the inferring is based on the gathering and the collecting, and wherein the additional information is added to the user-specific data vector. Embodiments can include inferring, using one or more processors, additional information about the plurality of users, wherein the inferring is based on the gathering, and wherein the additional information is added to the user-specific data vector. In embodiments, the inferring includes a prediction of biographic, geographic, or demographic information. Embodiments can include collecting video consumption behavior information on the plurality of users. In embodiments, the collecting is accomplished using online data sources, wherein the online data sources include one or more video sites. In embodiments, the online data sources include metadata. In embodiments, the metadata includes hashtags, repost velocity, participant attributes, participant history, ranking, purchase history, view history, or participant actions. Embodiments can include gathering shopping history information on the plurality of users. In embodiments, gathering shopping history information on the plurality of users comprises gathering online shopping history. In embodiments, the shopping history includes shopping demographics. In embodiments, the shopping demographics include at least one of salary, education, age, or gender. In embodiments, the shopping history includes user ID, services, or events purchased or viewed, repeat purchases, and previous vendors. Embodiments can include forming a taxonomy, for the plurality of users, of products purchased, wherein the taxonomy includes purchase details.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

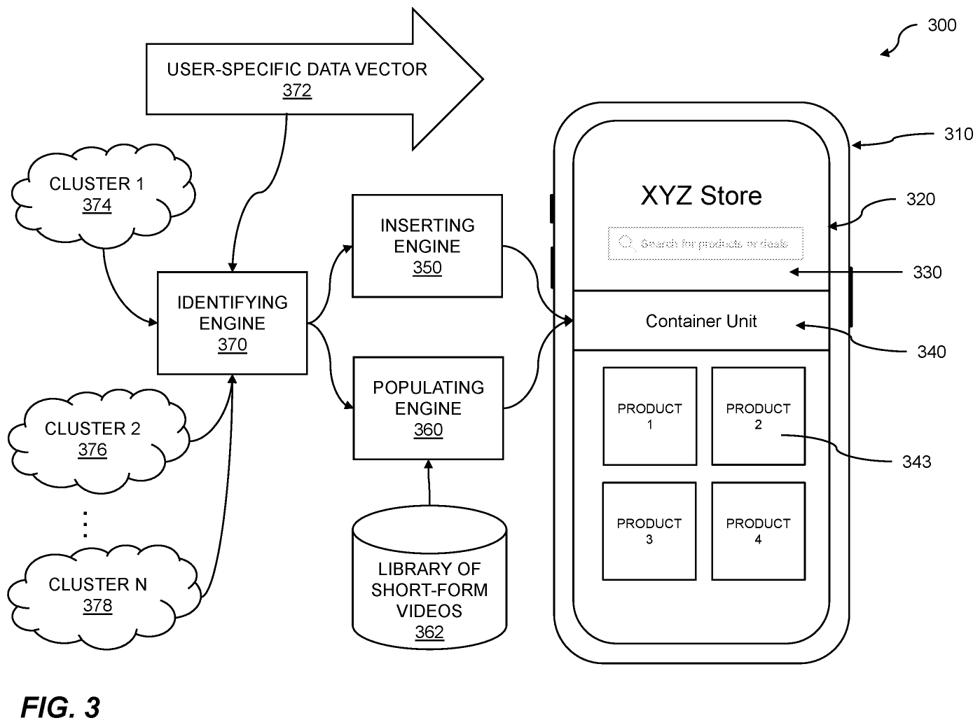

FIG. 3 is an infographic 300 for cluster-based dynamic content with multi-dimensional vectors. A user-specific data vector 372 is input to an identifying engine 370. The identifying engine 370 compares the user-specific data vector to multiple clusters, indicated as cluster 1 (374), cluster 2 (376), and cluster N (378). While three clusters are shown in FIG. 3, in practice, there can be many thousands of clusters. In some embodiments, the identifying engine 370 may identify the top G matching clusters, where G can be a predetermined value established for optimal performance within a given system. In some embodiments, the value of G can be a nearest-rounded integer value of a percentage P of the total number of clusters N. As an example, with 3,215 clusters and P set to two percent, the value of G is then computed as INT(0.02×3125)=64. In this example, up to 64 matching clusters may be identified as corresponding to the user-specific data vector 372.

Each cluster may have categories and/or attributes associated with it. The attributes can include topics, subjects, video sources, video length preferences, and so on. After the identifying engine identifies one or more clusters, the corresponding attributes are used to select videos for dissemination. An inserting engine 350 inserts a container unit 340 into media content 330 that is rendered on an electronic display 320 of an electronic computing device 310. The electronic computing device 310 can include a smartphone, tablet computer, wearable computer, and/or other suitable electronic computing device. The container unit 340 is an area allocated for one or more video representations. The video representations can include static thumbnails, video thumbnails, hyperlinks, and so on. In embodiments, the container unit 340 is sized based on the number of video representations to present. In some embodiments, the container unit 340 is sized dynamically. The populating engine 360 populates the container unit 340 with the video representations, which can be widgets, thumbnails, hyperlinks, icons, and/or other suitable video representations. In some embodiments, thumbnail images and/or videos are retrieved from the library of short-form videos 362.

Embodiments can include rendering one or more product cards, indicated generally as 343, on the electronic display 320 of electronic computing device 310. The product cards are selectable via a user interface action such as a press, swipe, gesture, mouse click, verbal utterance, or other suitable user action. The product cards can enable the ecommerce purchase of a product. The product can be selected based on the user-specific data vector, and/or attributes of clusters that are identified by the identifying engine 370 as being mathematically related to the user-specific data vector. As an example, if an identified cluster pertains to automobiles, then automobile-related products, such as accessories and/or apparel, may be offered for sale by use of the product cards.

When the product card is invoked, an additional on-screen display is rendered over a portion of the video while the video continues to play. This enables a user to purchase a product/service while preserving a continuous video playback session. Allowing the video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

In embodiments, the enabling an ecommerce purchase of a product for sale to the user includes a representation of the product for sale in an on-screen product card. In embodiments, the on-screen product card includes text, a picture, a line drawing, an icon, or an emoji. In embodiments, the at least one short-form video comprises a livestream or livestream replay. In embodiments, the media content is communicated using a software application. In embodiments, the media content is communicated using a webpage.

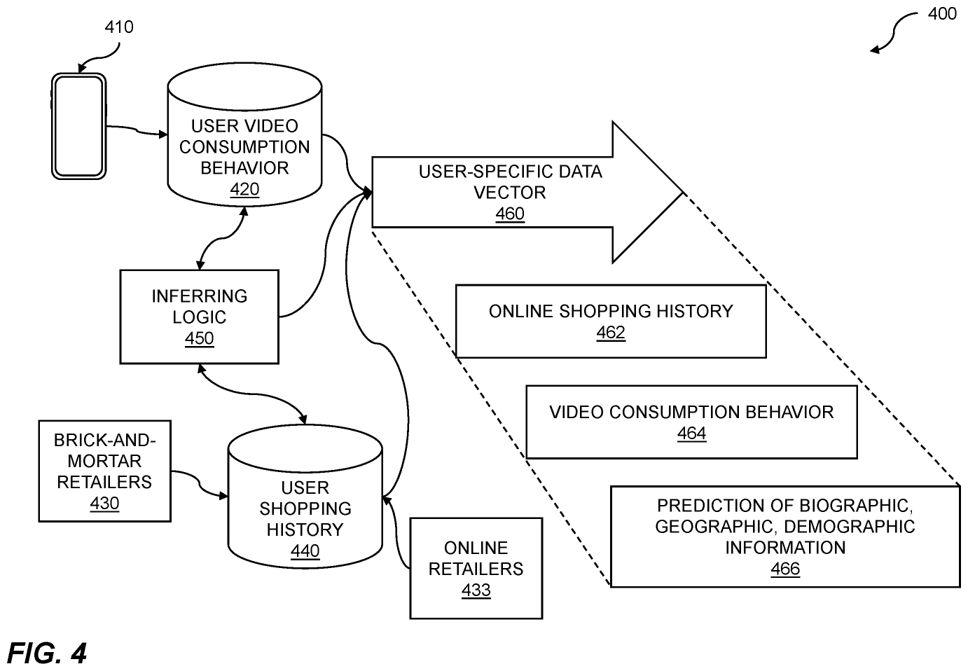

FIG. 4 is an infographic 400 for creating a user-specific multi-dimensional vector. An electronic computing device 410, such as a smartphone, tablet computer, or the like, is used by an individual to consume video content. The consumption can include browsing and/or watching short-form videos. A database of user video consumption behavior 420 stores video consumption behavior information obtained from the electronic computing device 410. The behavior can include a video topic, such as bicycle repair, cooking, etc. The behavior can include an average video viewing duration (how long a viewer typically views a video before disengaging with it). The behavior can include a completion ratio (how often a viewer watches a video to its end).

A user shopping history database 440 contains information about both online retailers 433, and brick-and-mortar (offline) retailers 430. The user shopping history information can include information on shopping frequency (how often the user visits a retail store or online website), shopping dwell time (how long the user remained at a retail store or online website), shopping budget (average amount spent per shopping visit), shopping schedule (e.g., which days, and/or time of day, the user typically shops), items purchased, coupons used, and/or other shopping history information. Inferring logic 450 evaluates the user video consumption behavior 420 and the user shopping history 440 from the respective databases and includes that information within the user-specific data vector 460 as video consumption behavior 464 and/or the user online shopping history 462. The inferred information from inferring logic 450 can include a prediction of biographic, geographic, and/or demographic information 466. In some embodiments, when actual information is received that supersedes the inferred information, the inferred information is updated within the user-specific data vector 460. The user-specific data vector can include online shopping history 462, video consumption behavior 464, and/or predicted/inferred information, including biographic, geographic, and/or demographic information. The user-specific data vector can be analyzed via clustering, which compares user-specific data vector 460 to a collection of previously obtained user-specific data vectors that were categorized into one or more clusters.

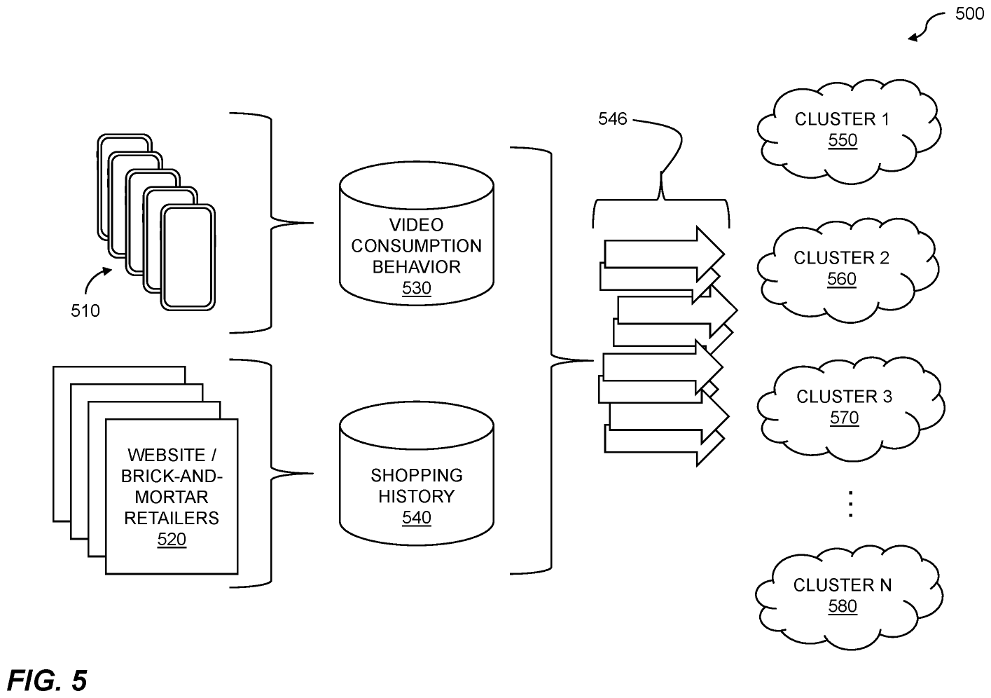

FIG. 5 is an infographic 500 for creating clusters. Multiple electronic devices 510 provide video consumption behavior information 530. In embodiments, at least some of the multiple electronic devices 510 are associated with a single individual, such as a mobile telephone associated with a particular individual. In practice, there can be many thousands of such devices participating in a system for video content dissemination in accordance with disclosed embodiments. Multiple websites and/or brick-and-mortar retailers 520 provide shopping history 540. The information from the shopping history 540 and video consumption behavior 530 is used to create multiple user-specific data vectors 546, where each user-specific data vector corresponds to actions of a unique individual. The user-specific data vectors 546 are then associated with one or more clusters, indicated as cluster 1 (550), cluster 2 (560), cluster 3 (570), and cluster N (580). In practice there can be millions of user-specific data vectors 546 assigned to one or more clusters. In practice there can be many thousands of clusters. As new user-specific data vectors that correspond to new individuals are obtained, new clusters may be formed.

In some embodiments, user-specific data vectors may be deleted from the system after a predetermined amount of inactivity (e.g., 180 days). In this way, stale user-specific data vectors are purged from the system over time. This feature can accommodate the situation where a user moves to a different geographical area or cancels his/her accounts. When a user-specific data vector is deleted from the system, it can also be deleted from any clusters that it was previously associated with. Thus, the population of (number of user-specific data vectors associated with) a cluster can increase or decrease over time. In embodiments, when a cluster decreases below a predetermined level, the cluster is deleted to help conserve computing resources such as memory, processing cycles, and/or network bandwidth. Thus, embodiments can include gathering shopping history information. In embodiments, the gathering is accomplished by offline data sources, wherein the offline data sources include one or more brick-and-mortar retail databases. In embodiments, the offline data is shared by a data exchange.

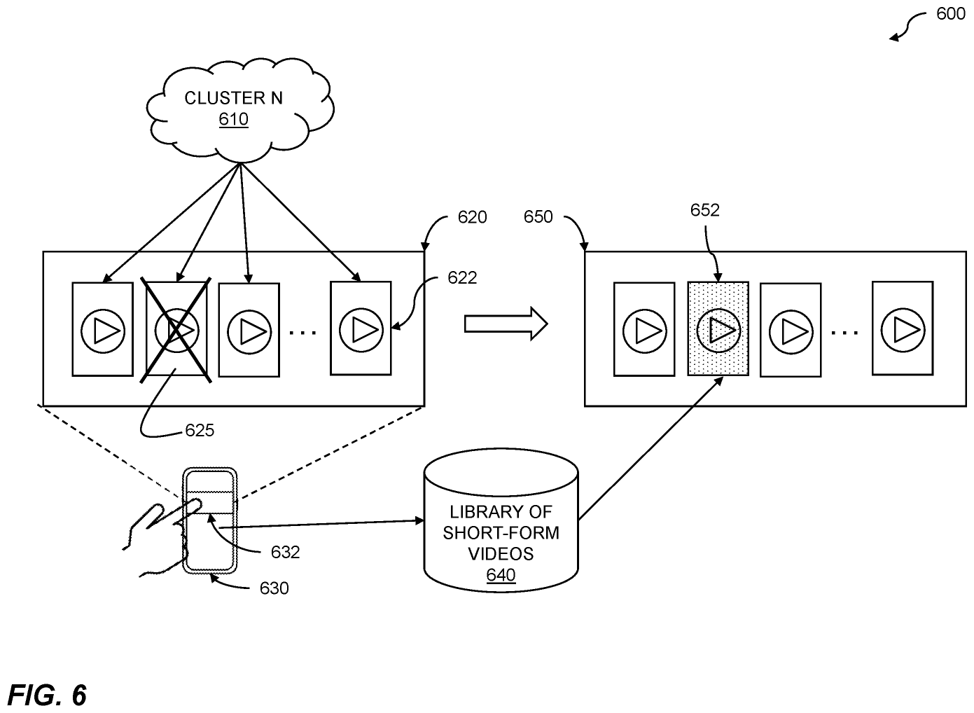

FIG. 6 is a diagram 600 for replacing videos. As shown in FIG. 6, a container unit 620 contains multiple video representations, indicated generally as 622. Each video representation can be an icon, static thumbnail, motion thumbnail, hyperlink, or other suitable representation. The video representations can be populated based on information in cluster 610. As an example, the cluster may pertain to the sport/activity of fishing, and the videos within container unit 620 may include representations of multiple short-form videos that pertain to fishing, and/or fishing-related products such as fishing poles, fishing hats, fishing tools, and the like. A user can view his/her electronic device 630, and a set of video representations shown in the container unit 632. The user can signify, via gesture, voice command, or onscreen action such as a tap or swipe, that he/she does not wish to see a particular short-form video. This short-form video is referred to as a discarded short-form video, indicated as 625. In embodiments, when a short-form video is discarded, a new video representation for a new short-form video, indicated as 652 in container unit 650 is used to replace the discarded short-form video. The new short-form video 652 is selected from the library of short-form videos 640. The selection can be based on the clustering analysis of the user-specific data vector for the user that is associated with electronic device 630. In this way, user engagement is improved, as videos that the user is not interested in viewing are replaced with other videos that the user is potentially interested in viewing. The videos can include sponsored videos. Sponsored videos can be subsidized by an advertiser or other stakeholder for a product. In some embodiments, sponsored videos are placed based on an auction system in which the highest bidder is awarded placement of a short-form video representation within a container unit. The short-form videos can include promoted videos. The promoted videos can include short-form videos that are endorsed by content providers that the user likes, based on his/her video consumption behavior. In some instances, the short-form videos are neither sponsored nor promoted, in which case, the short-form videos are referred to as “organic” short-form videos. In embodiments, the at least one related short-form video is promoted, organic, or sponsored.

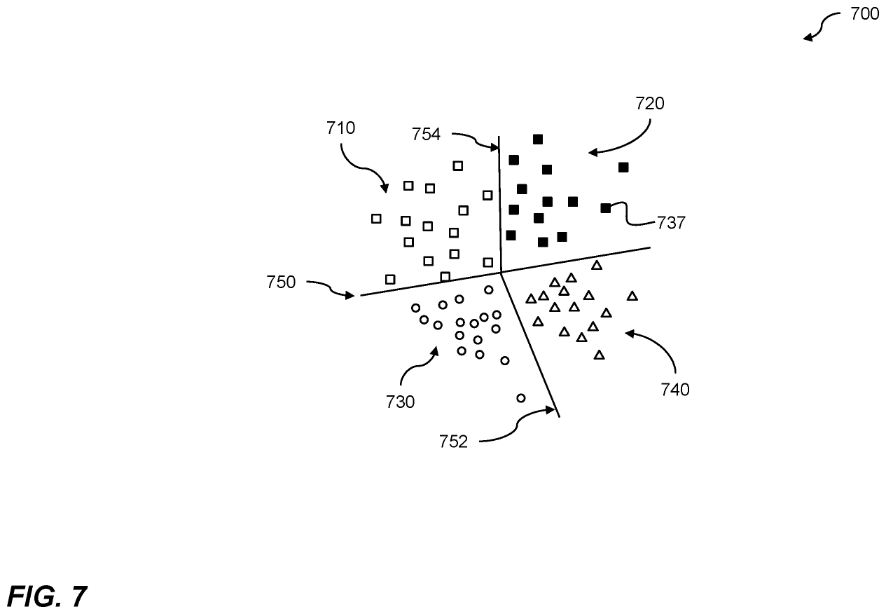

FIG. 7 is a diagram 700 showing clustering with machine learning. Diagram 700 includes multiple axes, indicated as 750, 752, and 754. The axes form various sections, indicated as 710, 720, 730, and 740. Each section can include one or more data points, indicated generally as 737. Each data point is representative of one or more user-specific data vectors. The user-specific data vectors can be associated with a section based on mathematical operations. The mathematical operations can include averaging, computing standard deviations, curve fitting, regression analysis, and/or other operations. Each section can correspond to a cluster. Each cluster can be associated with one or more attributes. The attributes can include user preferences, such as topics and/or genres of videos, subjects of interest, demographic information, geographic information, occupation information, age brackets, income brackets, and/or other relevant information. When a new user-specific data vector is obtained, and associated with a cluster, one or more of the attributes of that cluster may be inferred to be present for the user associated with the new user-specific data vector. Based on the inferred attributes, specific short-form videos and/or product cards can be presented to the user. In this way, disclosed embodiments provide a platform for improved engagement and product promotion via short-form video dissemination.

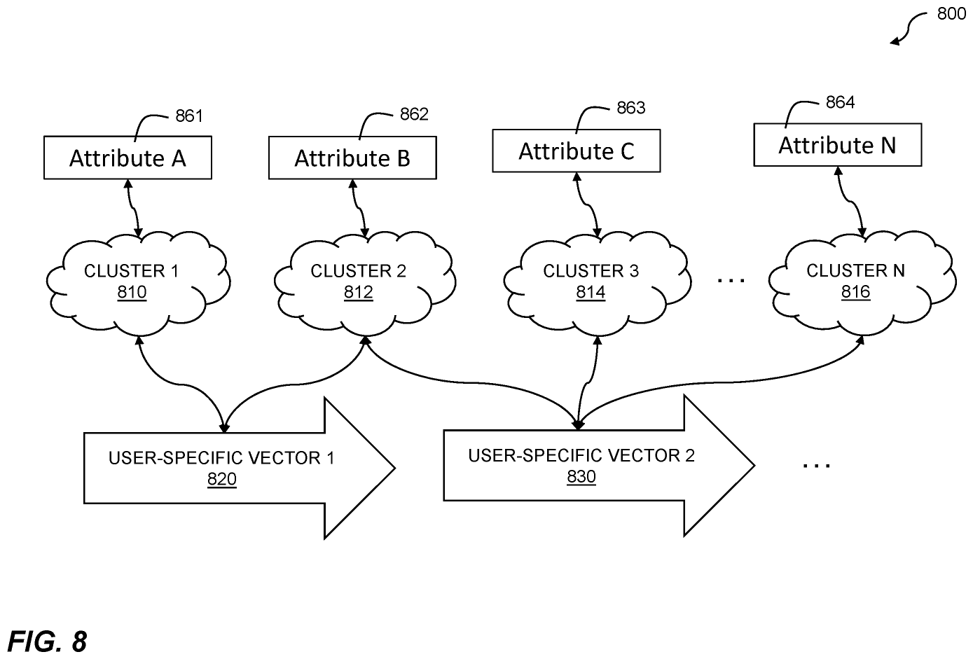

FIG. 8 is an infographic 800 for associating user-specific vectors with clusters. FIG. 8 shows two user-specific data vectors, indicated as 820 and 830. In practice, there can be millions of user-specific data vectors. FIG. 8 shows four clusters, indicated as cluster 1 (810), cluster 2 (812), cluster 3 (814), and cluster N (816). While four clusters are shown in FIG. 8, in practice, there can be many thousands of clusters. Each cluster includes one or more user-specific data vectors. A single user-specific data vector can belong to more than one cluster. As can be seen in FIG. 8, user-specific data vector 1 (820) belongs to cluster 1 (810) and cluster 2 (812). Similarly, user-specific data vector 2 (830) belongs to cluster 2 (812), cluster 3 (814), and cluster N (816). Also shown in FIG. 8, multiple user-specific data vectors can belong to a cluster, as user-specific data vector 1 (820) and user-specific data vector 2 (830) both belong to cluster 2 (812). Each cluster can represent one or more attributes. Attributes can include interests, preferences, demographics, and/or other user-specific information. As shown in FIG. 8, cluster 1 (810) is associated with attribute A (861), cluster 2 (812) is associated with attribute B (862), cluster 3 (814) is associated with attribute C (863), and cluster N (816) is associated with attribute N (864). In the example of FIG. 8, both user-specific data vector 1 (820) and user-specific data vector 2 (830) correlate to a common attribute, attribute B (862). When user-specific data vectors are associated with a given cluster, based on mathematical and/or machine learning analysis, the corresponding attributes of the associated cluster may be inferred as belonging to the user associated with the user-specific data vector. In embodiments, short-form videos can be disseminated to the user based on the associated cluster and/or its corresponding attributes.

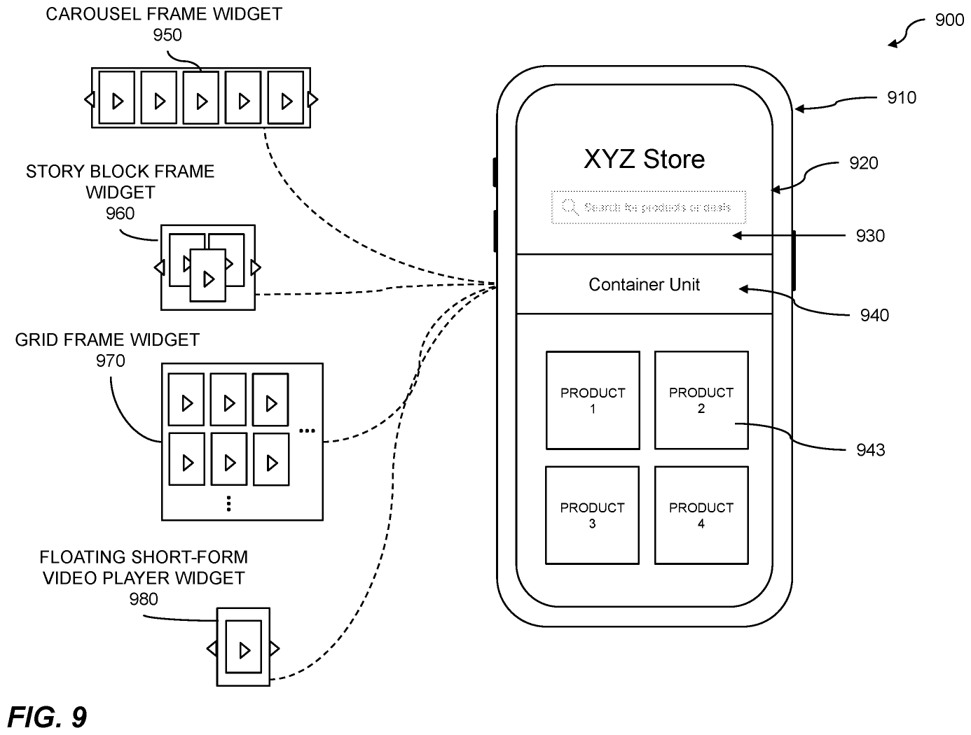

FIG. 9 shows an example of populating a container unit. In the example 900, an electronic computing device 910 can include a smartphone, tablet computer, or other suitable computing device. The device 910 includes an electronic display 920. In embodiments, the electronic display 920 is also a touchscreen that can receive user input via fingers, stylus, or other suitable techniques. Media content 930 is rendered on an electronic display 920 of an electronic computing device 910. The container unit 940 is an area allocated for one or more video representations. The video representations can include static thumbnails, video thumbnails, hyperlinks, and so on. In embodiments, the container unit 940 is sized based on the number of video representations to present. Embodiments can include rendering one or more product cards, indicated generally as 943, on the electronic display 920 of electronic computing device 910. The product cards are selectable via a user interface action such as a press, swipe, gesture, mouse click, verbal utterance, or other suitable user action. The product cards can enable the ecommerce purchase of a product.

The container unit 940 can be inserted into a website and/or can be overlaid on a short-form video window. The container unit 940 can contain one or more content widgets, as shown in FIG. 9. The container unit can be formatted in story block, carousel, floating, or grid formats. A story block frame container unit 960 arranges the optimized short-form videos within the container unit so that the highest scoring video is on top, being obvious to the user, with the following highest scoring videos immediately beneath, and so on, down to the lowest scoring video. In embodiments, the optimizing score can be based on the likelihood of the user purchasing the displayed product or service highlighted in the video. For example, a user may search for videos related to a cordless drill. After accessing and searching the short-form video library, videos related to the cordless drill contained in the search request are selected. The selected videos can then be optimized based on metadata, celebrity endorsements, advertiser bids, and conversion rates. The video with the lowest score is placed into the empty container unit first, on the right side, followed by the middle scoring video on the left side. Finally, the highest scoring video is placed on top of the other two videos, partially covering them, and centered in the container unit. Thus, the user naturally views the top video first, then the remaining videos from left to right.

A carousel frame container unit 950 arranges the optimized videos within the container so that the highest scoring video is farthest to the left, the next highest video immediately to the right of the first video, and so on. In some embodiments, the short-form videos can be arranged in a carousel to relate a story or narrative in order. This allows a user to view essential information related to a product or service first, followed by less important information, much in the same way that newspaper articles are written with the headline and leading paragraph containing the most vital details. A floating short-form video player container unit 980 places the highest scoring short-form video on top, with the next highest video immediately behind it, and so on. Only one video is visible at a time in a floating video player. In some embodiments, the floating video player container unit can be moved by the user to any section of the website, allowing the user to view other information or additional products or services while the videos are playing. A grid frame container unit 970 arranges the optimized videos in rows and columns, with the highest scoring video generally in the top left corner. The grid frame container allows videos and other related elements, such as banners, sale information, etc., to be placed in specific locations within the container using X-Y coordinates. This gives the advertiser or website designer flexibility when placing videos within the container unit based on screen size or other criteria. In embodiments, the container unit comprises a story block, carousel, floating player, or grid.

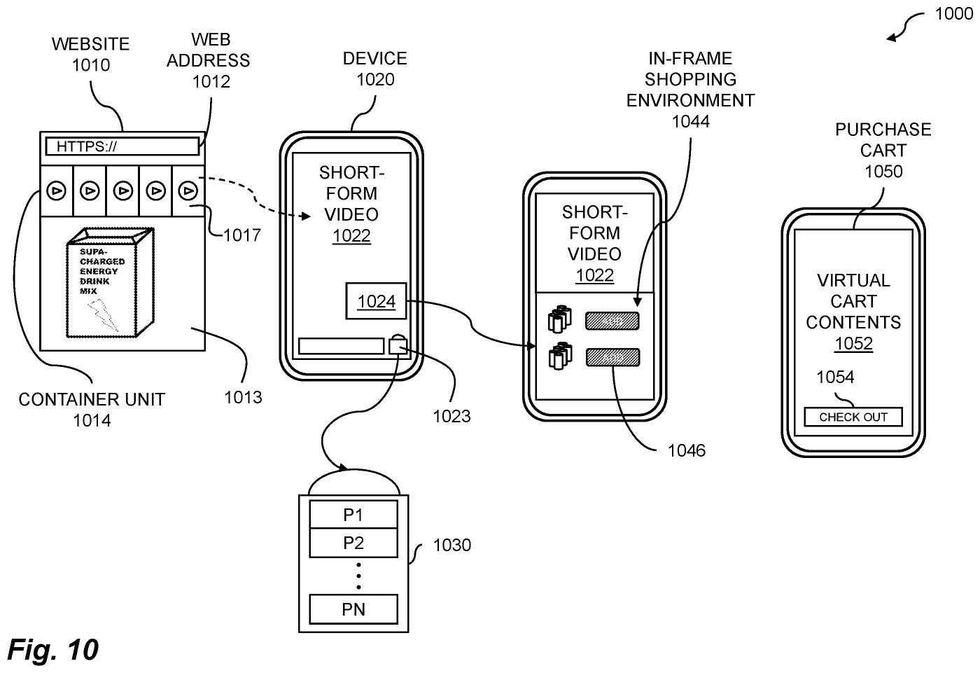

FIG. 10 shows an example of an ecommerce purchase with a container unit. In the example 1000, a website 1010 renders a webpage 1013 based on a web address 1012. A container unit 1014 contains multiple short-form video representations, such as thumbnails, indicated generally as 1017. A short-form video 1022 corresponding to a short-form video representation can be rendered on device 1020, and a product card 1024 for a product that is relevant to the short-form video 1022 can also be displayed. The product card 1024 can enable an ecommerce purchase. When the product card 1024 is invoked, an in-frame shopping environment 1044 is rendered along with the short-form video 1022. The playback of short-form video 1022 can continue while the in-frame shopping environment 1044 is rendered. An add control 1046 enables an item to be added to a virtual purchase cart 1030. The virtual purchase cart, which can include a virtual shopping cart, a virtual shopping bag, a virtual tote, etc., can include one or more products selected for purchase by the user. The products can include product P1, product P2, and so on up to product PN. In embodiments, a representation of the virtual purchase cart can be displayed on the device. The representation is visible while viewing the short-form video. Information associated with the virtual purchase cart and its contents can be provided to a rendering engine for display on the device. When the user invokes the purchase cart control 1023, the purchase cart 1050 is shown, and the virtual cart contents 1052 are displayed. Once the user is ready to complete the ecommerce purchase, they can invoke the check-out control 1054 to complete the purchase.

In embodiments, the enabling includes a virtual purchase cart. In embodiments, the at least one related short-form video displays the virtual purchase cart while the video plays. In embodiments, the virtual purchase cart covers a portion of the at least one related short-form video. In embodiments, the media content is included on a website running on a portable device. In embodiments, the media content is included in an application running on a portable device.

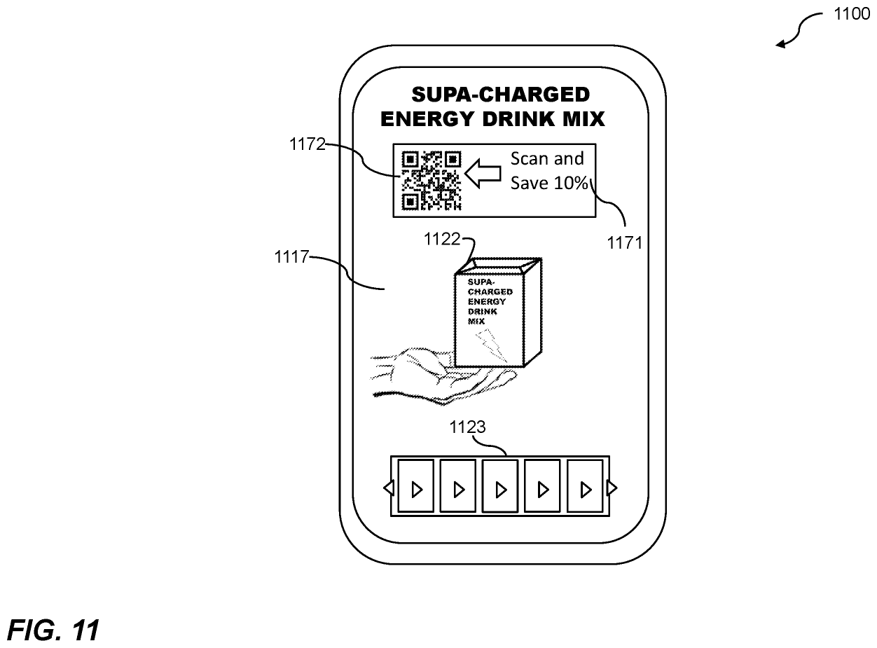

FIG. 11 shows an example of an ecommerce purchase with coupon overlay. In the example, electronic device 1100 can include a smartphone, tablet computer, or other suitable device. The electronic device 1100 includes an electronic display 1117. A short-form video for a product 1122 is shown in the display 1117. The short-form video can be selected from a video representation such as a thumbnail within container unit 1123. A coupon overlay 1171 is displayed over the short-form video during its playback on the electronic display 1117. In some embodiments, the coupon overlay 1171 can include a QR code 1172 that can be scanned with a mobile device, barcode reader, or other suitable device, for redeeming during an ecommerce purchase. In embodiments, the enabling an ecommerce purchase further comprises presenting a coupon overlay, to the user, in the at least one short-form video populated in the container unit. In embodiments, the presenting is based on shopping history.

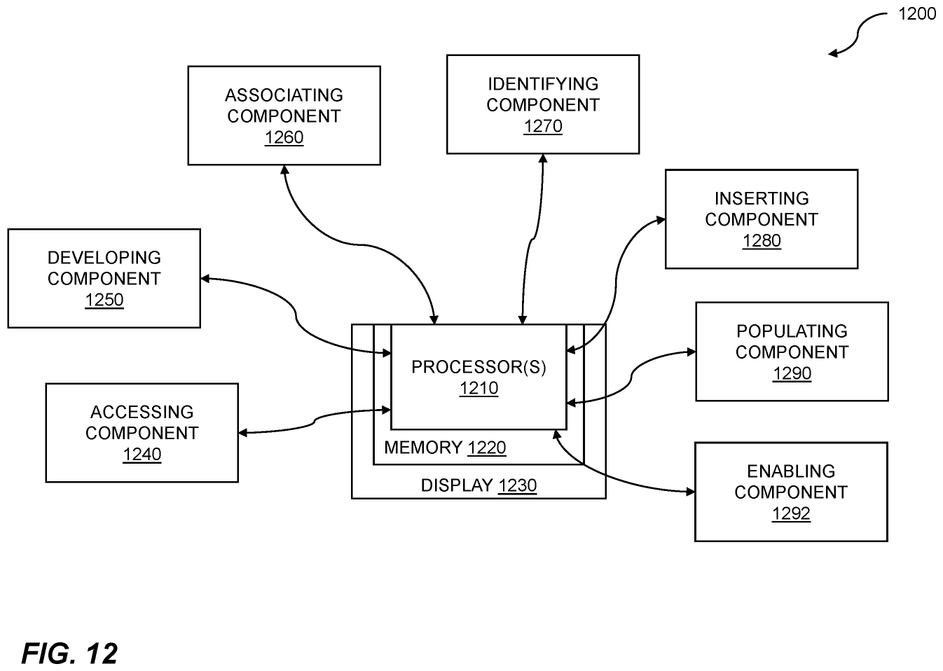

FIG. 12 is a diagram for a system 1200 for cluster-based dynamic content with multi-dimensional vectors. The system 1200 can include one or more processors 1210 coupled to a memory 1220 which stores instructions. The system 1200 can include a display 1230 coupled to the one or more processors 1210 for displaying data, video streams, videos, product information, virtual purchase cart contents, webpages, intermediate steps, instructions, and so on. In embodiments, one or more processors 1210 are coupled to the memory 1220 where the one or more processors, when executing the instructions which are stored, are configured to: access user-specific data vectors on a plurality of users, wherein the user-specific data vectors include shopping history and video consumption behavior; develop, using one or more processors, a plurality of clusters based on the user-specific data vectors; associate a user from the plurality of users with one or more clusters from the plurality of clusters; identify that the user, from the plurality of users, is viewing media content, wherein the user is associated with the one or more clusters; insert a container unit into the media content that is being viewed by the user; populate the container unit with at least one short-form video from a library of short-form videos, wherein the populating is based on the identifying; and enable an ecommerce purchase of a product for sale to the user, wherein the product for sale is relevant to the cluster and the at least one short-form video, and wherein the ecommerce purchase is accomplished within the short-form video window.

The system 1200 can include a computer program product embodied in a non-transitory computer readable medium for video content, the computer program product comprising code which causes one or more processors to perform operations of: accessing user-specific data vectors on a plurality of users, wherein the user-specific data vectors include shopping history and video consumption behavior; developing, using one or more processors, a plurality of clusters based on the user-specific data vectors; associating a user from the plurality of users with one or more clusters from the plurality of clusters; identifying that the user, from the plurality of users, is viewing media content, wherein the user is associated with the one or more clusters; inserting a container unit into the media content that is being viewed by the user; populating the container unit with at least one short-form video from a library of short-form videos, wherein the populating is based on the identifying; and enabling an ecommerce purchase of a product for sale to the user, wherein the product for sale is relevant to the cluster and the at least one short-form video, and wherein the ecommerce purchase is accomplished within the short-form video window.

The system 1200 can include an accessing component 1240. The accessing component 1240 can include functions and instructions for accessing one or more ecommerce short-form videos. The short-form videos can include livestreams and/or livestream replays. The accessing can include obtaining a uniform resource locator (URL) for a short-form video residing in a network-accessible library. The accessing can include initiating a playback session via HLS (HTTP Live Streaming), MPEG-DASH (Dynamic Adaptive Streaming over HTTP), WebRTC, RTSP (Real-Time Streaming Protocol), and/or other suitable protocols.

The system 1200 can include a developing component 1250. The developing component 1250 can include functions and instructions for developing multiple clusters based on obtained user-specific data vectors. The developing component may utilize non-hierarchical clustering techniques such as a K-means algorithm and/or bisecting K-means algorithm. In some embodiments, the developing component may utilize hierarchical clustering methods, connectivity-based clustering, and/or other suitable clustering techniques.

The system 1200 can include an associating component 1260. The associating component 1260 can include functions and instructions for associating a user with one or more of the clusters. This can be accomplished by performing a clustering analysis on a user-specific data vector associated with the user to determine which cluster or clusters contain similar user-specific data vectors. In embodiments, the association can be based on cluster centroids. In some embodiments, a user-specific data vector is deemed to belong to a cluster if its multi-dimensional value(s) are within a predetermined distance from the centroid of that cluster.

The system 1200 can include an identifying component 1270. The identifying component 1270 can include functions and instructions for identifying that the user is viewing media content, where the user is associated with one or more clusters that were developed by the developing component 1250. The identifying can include utilization of API (application programming interface) calls provided by a short-form video library to determine that a short-form video is currently being streamed, and to show the identity of the requestor.

The system 1200 can include an inserting component 1280. The inserting component 1280 can include functions and instructions for inserting a container unit into media content, such as a display window of an electronic device such as a smartphone. The container unit can be populated with short-form video representations such as static thumbnails, motion thumbnails, hyperlinks, and/or other suitable video representations. The video representations can be arranged using a variety of display widgets, including, but not limited to, a carousel frame widget, a story block frame widget, a grid frame widget, and/or a floating short-form player widget.

The system 1200 can include a populating component 1290. The populating component 1290 can include functions and instructions for populating the container unit with relevant short-form videos, as determined from the cluster analysis performed on one or more user-specific data vectors. As an example, if a user-specific data vector indicates high levels of interests in golf, automobiles, and boating, then the populating can include populating the container unit with short-form videos pertaining to golf, automobiles, and/or boating. The short-form videos can include livestreams and/or livestream replays pertaining to golf, automobiles, and/or boating.

The system 1200 can include an enabling component 1292. The enabling component 1292 can include functions and instructions for enabling an ecommerce purchase of a product for sale to the user. In embodiments, an ecommerce system includes a pool of products. The products can be classified by categories. In embodiments, one or more products are selected based on categories that correspond to a user-specific data vector associated with a viewer of a short-form video. Thus, continuing with the example, products pertaining to golf, automobiles, and/or boating may be selected, and ecommerce purchases may be enabled by the use of product cards, coupon overlays, banner advertisements, and/or other suitable techniques. In this way, viewers of short-form videos are presented with opportunities to purchase relevant products based on the combined information of online and offline activities. This approach provides a more comprehensive assessment of user preferences, enabling streamlined ecommerce purchases that promote user engagement and enhance the entertainment value and customer experience for users.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video content analysis comprising:
accessing user-specific data vectors on a plurality of users, wherein the user-specific data vectors include shopping history and video consumption behavior;
developing, using one or more processors, a plurality of clusters based on the user-specific data vectors;
associating a user from the plurality of users with one or more clusters from the plurality of clusters;
identifying that the user, from the plurality of users, is viewing media content, wherein the user is associated with the one or more clusters;
inserting a container unit into the media content that is being viewed by the user;
populating the container unit with at least one short-form video from a library of short-form videos, wherein the populating is based on the identifying; and
enabling an ecommerce purchase of a product for sale to the user, wherein the product for sale is relevant to the one or more clusters and the at least one short-form video, and wherein the ecommerce purchase is accomplished within a short-form video window.

2. The method of claim 1 further comprising creating a user-specific data vector, based on gathering of shopping history, for inclusion in the user-specific data vectors on the plurality of users.

3. The method of claim 2 further comprising inferring, using one or more processors, additional information about the plurality of users, wherein the inferring is based on the gathering, and wherein the additional information is added to the user-specific data vector.

4. The method of claim 2 further comprising collecting video consumption behavior information on the plurality of users.

5. The method of claim 4 wherein the collecting is accomplished using online data sources, wherein the online data sources include one or more video sites.

6. The method of claim 5 wherein the online data sources include metadata.

7. The method of claim 2 wherein gathering shopping history information on the plurality of users comprises gathering online shopping history.

8. The method of claim 7 wherein the gathering is accomplished by offline data sources, wherein the offline data sources include one or more brick-and-mortar retail databases.

9. The method of claim 7 wherein the shopping history includes shopping demographics.

10. The method of claim 8 wherein the offline data sources are shared via a data exchange.

11. The method of claim 7 further comprising forming a taxonomy, for the plurality of users, of products purchased, wherein the taxonomy includes purchase details.

12. The method of claim 1 further comprising training and deploying a machine learning model to develop the plurality of clusters.

13. The method of claim 12 wherein the training includes weighting shopping history or video consumption behaviors within the user-specific data vectors.

14. The method of claim 12 wherein the training includes hints, based on prior knowledge of shopping history.

15. The method of claim 1 wherein the associating a user from the plurality of users is accomplished using hash tables.

16. The method of claim 1 wherein the enabling an ecommerce purchase of a product for sale to the user includes a representation of the product for sale in an on-screen product card.

17. The method of claim 1 wherein the enabling includes a virtual purchase cart.

18. The method of claim 17 wherein the at least one short-form video displays the virtual purchase cart while the short-form video plays.

19. The method of claim 17 wherein the virtual purchase cart covers a portion of the at least one short-form video.

20. The method of claim 1 wherein the populating the container unit further comprises, for each cluster within the plurality of clusters, building a video playlist, wherein the video playlist includes one or more related videos to the cluster from the library of short-form videos.

21. The method of claim 20 wherein the building a video playlist is based on hints, wherein the hints include biographic information, demographic information, geographic information, or shopping history.

22. The method of claim 20 wherein the building a video playlist includes an ability to replace the one or more related videos with one or more alternate videos from the library of short form videos.

23. The method of claim 1 wherein the enabling an ecommerce purchase further comprises presenting a coupon overlay, to the user, in the at least one short-form video populated in the container unit.

24. The method of claim 23 wherein the presenting is based on shopping history.

25. A computer program product embodied in a non-transitory computer readable medium for video content analysis, the computer program product comprising code which causes one or more processors to perform operations of:
accessing user-specific data vectors on a plurality of users, wherein the user-specific data vectors include shopping history and video consumption behavior;
developing, using one or more processors, a plurality of clusters based on the user-specific data vectors;
associating a user from the plurality of users with one or more clusters from the plurality of clusters;
identifying that the user, from the plurality of users, is viewing media content, wherein the user is associated with the one or more clusters;
inserting a container unit into the media content that is being viewed by the user;
populating the container unit with at least one short-form video from a library of short-form videos, wherein the populating is based on the identifying; and
enabling an ecommerce purchase of a product for sale to the user, wherein the product for sale is relevant to the one or more clusters and the at least one short-form video, and wherein the ecommerce purchase is accomplished within a short-form video window.

26. A computer system for video content analysis comprising:
a memory which stores instructions;
one or more processors coupled to the memory wherein the one or more processors, when executing the instructions which are stored, are configured to:
access user-specific data vectors on a plurality of users, wherein the user-specific data vectors include shopping history and video consumption behavior;
develop, using one or more processors, a plurality of clusters based on the user-specific data vectors;
associate a user from the plurality of users with one or more clusters from the plurality of clusters;
identify that the user, from the plurality of users, is viewing media content, wherein the user is associated with the one or more clusters;
insert a container unit into the media content that is being viewed by the user;
populate the container unit with at least one short-form video from a library of short-form videos, wherein populating is based on identifying; and
enable an ecommerce purchase of a product for sale to the user, wherein the product for sale is relevant to the one or more clusters and the at least one short-form video, and wherein the ecommerce purchase is accomplished within a short-form video window.
